(19) United States
(12) Patent Application Publication
(10) Pub. No.: US 2023/0419797 A1
(43) Pub. Date: Dec. 28, 2023

(54) MAGNETIC TAMPER DETECTION AND DIAGNOSTICS FOR SMART SECURITY SYSTEMS

(71) Applicant: Allegro MicroSystems, LLC, Manchester, NH (US)

(72) Inventor: Joseph D. Hollins, Salem, NH (US)

(73) Assignee: Allegro MicroSystems, LLC, Manchester, NH (US)

(21) Appl. No.: 17/808,564

(22) Filed: Jun. 24, 2022

(51) Int. Cl. G08B 13/14; G06F 21/86

(52) U.S. Cl. CPC G08B 13/149; G06F 21/86

(57) ABSTRACT

Magnetic field tampering detection and diagnostic systems are configured to detect a tampering event for an electronic security system or device. The magnetic field tampering detection system can include a memory; and a processor coupled to the memory and configured to receive a magnetic field measurement signal from one or more magnetic field sensors configured to detect a magnetic field incident on the security system or device, where the processor is configured to determine when the magnetic field measurement signal corresponds to a tampering event outside of a normal range of operation, and where the processor is configured to generate a response when a tampering event is determined to have occurred. The systems can perform remedial actions in response to detected tampering events.

### BACKGROUND

Many security systems and access-control devices—such as electronic locks, cameras, intrusion sensors, garage door openers, control hubs and panels—contain increasing levels of so-called “smart” electronics, including ones connected to and accessible through the Internet or other communication networks, that enable automated access to permitted users while restricting access to intruders. As consumers find new ways to outfit their living spaces with simple-to-use so-called “smart” home products and Internet-connected “Internet of Things” (IoT) devices, they may be unaware of certain vulnerabilities and security issues commonly found in these and other electronic devices.

For example, the electronics systems and circuits present in such smart systems and devices may be susceptible to various forms of tampering, attack, or sabotage. One type of tampering or attack can include application of a strong magnetic field to disrupt or prevent correct operation of the electronics in such systems and devices. In some situations, such systems and devices may be rendered inoperative or caused to malfunction through acts of intentional tampering by nefarious actors.

### SUMMARY

One general aspect of the present disclosure includes a magnetic field tampering detection system for detecting a tampering event for an electronic security system or device. The magnetic field tampering detection system can includes a memory; and a processor coupled to the memory and configured to receive a magnetic field measurement signal from one or more magnetic field sensors configured to detect a magnetic field incident on the security system or device, where the processor is configured to determine when the magnetic field measurement signal corresponds to a tampering event outside of a normal range of operation, and where the processor is configured to generate a response when a tampering event is determined to have occurred. Other embodiments of this aspect include corresponding computer systems, apparatus, and computer programs recorded on one or more computer storage devices, each configured to perform the actions of the methods.

Implementations may include one or more of the following features. The system memory may include computer-executable instructions, and where the processor can be operative to execute the computer-executable instructions, the computer-executable instructions causing the processor to: receive the magnetic field measurement signal from the one or more magnetic field sensors configured to detect a magnetic field incident on the device; perform a comparison of the magnetic field measurement signal to a normal range of operation; determine that a parameter of the comparison indicates a tampering event was associated with the magnetic field measurement signal; and initiate a response to the tampering event. The response may include disabling the device for a period of time. The response may include disabling a user input to the device for a period of time. The processor can be further configured to generate a notification in response to the tampering event. The processor can be further configured to apply compensation to the magnetic field measurement signal from the one or more sensors and/or any additional device magnetic sensors in response to the tampering event. The compensation may include an attenuation factor sufficient to place the magnetic field measurement signal in a normal range of operation. Implementations of the described techniques may include hardware, a method or process, or computer software on a computer-accessible medium.

Another aspect of the present disclosure can include a magnetic tampering detection system for detecting a tampering event for an electronic device. The magnetic tampering detection system also includes one or more magnetic field sensors, each configured to detect a stray magnetic field at a respective location of the device; a memory may include computer-executable instructions; and a processor coupled to the memory and operative to execute the computer-executable instructions, the computer-executable instructions causing the processor to: receive a magnetic field measurement signal from the one or more magnetic field sensors; perform a comparison of the magnetic field measurement signal to a normal range of operation; determine that a parameter of the comparison indicates a tampering event was associated with the magnetic field measurement signal; and initiate a response to the tampering event. Other embodiments of this aspect may include corresponding computer systems, apparatus, and computer programs recorded on one or more computer storage devices, each configured to perform the actions of the methods.

Implementations may include one or more of the following features. The one or more magnetic field sensors may include omnipolar sensors. The one or more magnetic field sensors may include omnidirectional sensors. The one or more magnetic field sensors may include Hall effect elements. The one or more magnetic field sensors may include magnetoresistive elements. The one or more magnetic field sensors may include multi-axis (e.g., 3D, 2D) Hall effect and/or magnetoresistive sensors. The device may include an actuator. The device may include a current meter. The device may include a position sensor, where the one or more magnetic field sensors are configured to detect a stray magnetic field at the position sensor. The device may include a current sensor, where the one or more magnetic field sensors are configured to detect a stray magnetic field at the current sensor. The device may include a motor driver integrated circuit, where the one or more magnetic field sensors are configured to detect a stray magnetic field at the motor driver integrated circuit. The device may include an actuator, where the one or more magnetic field sensors are configured to detect a stray magnetic field at the actuator. The device may include one or more memories, where the one or more magnetic field sensors are configured to detect a stray magnetic field at the one or more memories.

The device may include DC regulation circuitry, where the one or more magnetic field sensors are configured to detect a stray magnetic field at the DC regulation circuitry. The DC regulation circuitry may include DC conversion circuitry. The DC regulation circuitry may include a buck regulator. The DC regulation circuitry may include a boost regulator. The DC regulation circuitry may include a magnetic DC-DC convertor. The DC regulation circuitry may include a buck-boost convertor. The DC regulation circuitry may include a flyback convertor having a transformer. The device may include power monitoring circuitry, where the one or more magnetic field sensors are configured to detect a stray magnetic field at the power monitoring circuitry. The power monitoring circuitry may include voltage monitoring circuitry. The power monitoring circuitry may include current monitoring circuitry. The device may include battery level monitoring circuitry, where the one or more magnetic field sensors are configured to detect a stray magnetic field at the battery level and health monitoring circuitry. The device may include battery protection circuitry, where the one or more magnetic field sensors are configured to detect a stray magnetic field at the battery protection circuitry.

The device may include charging circuitry, where the one or more magnetic field sensors are configured to detect a stray magnetic field at the charging circuitry. The processor, memory, and one or more magnetic field sensors are disposed in an integrated circuit. The system may include a magnetic proximity detection sensor configured to detect movement of the device relative to an installation position. The latching circuitry can be configured to apply compensation for the magnetic field measurement signal exceeding the latch threshold. The latching circuitry can be configured to deactivate the device for a predetermined period of time in response to the magnetic field measurement signal exceeding the latch threshold. The latching circuitry can be configured to apply compensation, which may include an attenuation of the magnetic field measurement signal and/or sensitivity of the magnetic field sensing element(s)/sensor(s) or other suitable compensation. The latching circuitry can be configured to apply a countering effect to the device to counter the effect of the magnetic tampering event. Compensation can include adjusting magnetic field sensitivity of one or more of the magnetic field sensors, e.g., by adjusting one or more memory (EEPROM) setting(s) of the sensor(s). The magnetic field sensitivity may be lowered in some applications, for example; in other applications, it may be increase. Such adjustment may be limited or permanent in duration. Implementations of the described techniques may include hardware, a method or process, or computer software on a computer-accessible medium.

A system of one or more computers can be configured to perform particular operations or actions of described aspects and embodiments by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIG. 1 is a diagram showing an example of a smart lock including a tampering detection and diagnostics system, in accordance with the present disclosure;

FIG. 2 is a diagram of an example processing and diagnostics system configured to detect magnetic tampering events in a smart security system, in accordance with the present disclosure;

FIG. 3 is a diagram of tampering detection and diagnostics system employed with a smart garage door gate system, in accordance with the present disclosure;

FIG. 4 is a diagram of an example of a tampering detection and diagnostics system employed with a smart door locking mechanism, in accordance with the present disclosure; and

FIG. 5 is a diagram of an example computer system, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Prior to describing examples and embodiments of the present disclosure some information is provided for context.

Various mechanical and electronic systems are potential targets for magnetic tampering. So-called “smart” devices, which can be considered as devices or systems with electronic access and/or communication functionality, may be particularly susceptible to such tampering due to their included electronic components and circuits. Unscrupulous or nefarious individuals may attack deployed electronic smart systems, hoping to alter or disable them or steal product or service, or enter into secured areas, buildings, or structures. Examples of smart security systems include, but are not limited to, electronic locks, doors, gates, and area monitoring systems, including video surveillance systems.

One of the many methods employed in tampering with smart systems and devices having electronics involves using strong magnets—of either permanent or electromagnetic types—to disrupt the ability of the electronics to operate in a closed loop. As these magnets are brought in close proximity to the system or device including electronics, the magnets begin to expose the internal electronics of the smart system or device to “stray” magnetic fields of increasing strength.

Externally-generated magnetic fields applied to a system or device are commonly referred to as stray magnetic fields. Stray magnetic fields can be unintentional, e.g., interference from a nearby large current or magnetic source, or intentional, e.g., applied during a tampering event by a nefarious perpetrator. Sources such as a permanent magnet or electromagnet can vary in polarity, frequency, direction, and strength. Permanent magnets used for tampering are typically very strong, may be relatively large and heavy, and can be purchased online or salvaged from discarded electronics and computers. So-called “super” magnetics, e.g., those utilizing alloys of rare-earth elements such as Neodymium, are notable examples of strong permanent magnets often used for tampering.

Stray magnetic fields can be static magnetic fields or alternating magnetic fields. The former can include non-periodic magnetic fields generated by, e.g., cars and trains, geomagnetism, etc. Both types of magnetic fields (static and alternating) can be generated in the course of intentional tampering, e.g., using one or more permanent magnet and/or electromagnets. Stray magnetic fields can conflict or interfere with desired operation of systems and devices that rely on magnetic fields or magnetic field sensors for normal operation.

So-called smart security (access control) systems with control and communication electronics may present hardware and/or software security susceptibilities to tampering with intentionally applied magnetic fields. The internal electronics of such these access control systems typically use voltage and current references, which are often sensitive to external magnetic fields. Application of a strong magnetic field (as a magnetic interference or tampering event) could potentially cause such a system to become blinded or tricked into performing an operation when it should remain secured. In the case of a smart lock, a very high magnetic field applied may allow an intruder to enter a secure space or building.

Known magnetic field sensors can have susceptibilities to tampering. For example, planar Hall effect elements and vertical Hall effect elements are known types of magnetic field sensing elements used for magnetic field sensors, where the term “sensor” can include reference to an integrated circuit (IC) including one or more transducers or elements. A planar Hall effect element tends to be responsive to magnetic fields perpendicular to a surface of a substrate on which the planar Hall effect element is formed. A vertical Hall effect element tends to be responsive to magnetic fields parallel to a surface of a substrate on which the vertical Hall effect element is formed. Magnetoresistance (xMR) elements are also known types of magnetic field sensing elements that are used for magnetic field sensors. Some types of magnetoresistance (a.k.a., magnetoresistive) elements tend to be responsive to magnetic fields parallel to a surface of a substrate on which the magnetoresistance element is formed.

Various magnetoresistive technologies have been used to create magnetic sensor ICs. These sensors usually have a planar response, i.e., they may detect fields in the X-Y plane but have limited response to fields in the orthogonal Z direction. In addition, very high magnetic fields can actually cause the sensor to saturate and malfunction, particularly in sensors with limited dynamic range. Since tampering is often attempted using a high-strength magnetic field, this can be a significant limitation.

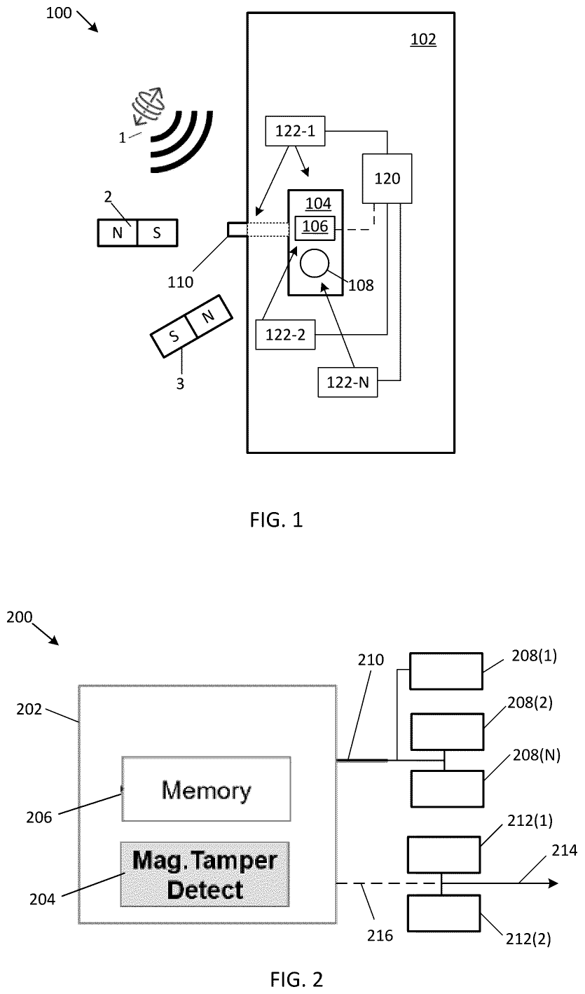

Moreover, various magnetic field sensors, including Hall effect and magnetoresistive (xMR) sensors, along with various other integrated circuits commonly used in security electronics, are susceptible to saturation and malfunction. During these conditions, the disruption to the magnetically sensitive components may prevent the system from knowing critical information such as how much power is flowing through it or the exact status of a mechanical position. For example, for the smart lock shown in FIG. 1 (described below), a strong applied (stray) magnetic field applied during a tampering event could potentially trigger an unlock condition in the locking mechanism.

FIG. 1 is a diagram showing an example of a smart lock including a tampering detection and diagnostics system 100, in accordance with the present disclosure. System 100 includes a smart lock 104 installed or applied to door 102. Smart lock 104 includes a control system (controller) 106, a user interface 108, and a locking mechanism indicated by deadbolt 110. System 100 includes a tampering detection and diagnostics system 120 having multiple magnetic field sensors 122(1)-(N). The magnetic field sensors are configured to detect magnetic stray fields applied to the smart lock 104 and/or related parts and components (as indicated by arrows), including magnetic fields applied as tampering events. Magnetic field sensors 122(1)-(N) can be located at desired locations within (internal to) or adjacent to smart lock 104, e.g., where stray magnetic fields could negatively impact performance of smart lock 104, including electronic and/or magnetic components.

In some examples, one or more magnetic field sensors 122(1)-(N) may be used as a magnetic proximity detection sensor configured to detect movement of the lock 104 relative to an installation position, e.g., as shown in the drawing. For example, if smart lock 104 were to be dismantled in an attempt to remove it from its mounting assembly or from door 102, a magnetic sensor, e.g., 122(1), could sense movement of the lock relative to its installed position. Tampering detection and diagnostics system 120 could detect such an attempt and provide a warning notice, e.g., to a system administrator, or take other responsive action.

In some examples, tampering detection and diagnostics system 120 can be included with installation of smart lock 104. In some examples, tampering detection and diagnostics system 120 can be included as a retrofit to a preexisting smart lock 104 in an application for door 102.

FIG. 2 is a diagram of an example tamper detection and diagnostics processing system 200 configured to detect magnetic tampering events in a smart security system, in accordance with the present disclosure. System 200 includes a processor subsystem 202, which can include a tamper detection controller or processor 204 connected to memory 206. The subsystem 202 can be connected to and receive signals from one or more magnetic field sensors 208(1)-(N) and/or 212(1)-(2). One or more magnetic field sensors, e.g., 208(1)-(2), may be connected directly to processor subsystem 202 as shown by direction connection 210. One or more magnetic field sensors, e.g., 212(1)-(2), may be connected to other components in system 200 or in a system monitored by system 200. For example, magnetic field sensors 212(1)-(2) are indicted with a connection 214 to an outside system (not shown) and also with an indirect connection 216 to processor subsystem 202. Other suitable connections and configurations may of course be employed.

Processor 204 can be configured, e.g., with suitable computer-readable instructions or software application(s), e.g., as stored in memory 206, to detect one or more magnetic tampering events based on signals received (directly and/or indirectly) from magnetic field sensors 208(1)-(N) and/or 212(1)-(2). Processor 204 can also be configured to provide diagnostic functionality, e.g., to analyze and/or respond to magnetic field measurement signals from magnetic field sensors 208(1)-(2) and/or 212(1)-(2). As explained in further detail below, magnetic field sensors 208(1)-(N) and/or 212(1)-(2) may be distributed within or adjacent to smart security systems and/or devices, e.g., at locations where magnetic fields or currents may occur.

In example embodiments, magnetic field sensors used to detect stray magnetic fields as described herein, e.g., magnetic field sensor 208(1)-(N) and/or 212(1)-(2), may have one or more of the following features/attributes: (1) High Sensitivity: certain metallic components used in the system may distort the magnetic field, resulting in “shadows” or “holes” in the sensor's detection region if the sensitivity is not high enough; (2) High Dynamic Range: some magnetic sensing technologies have upper bounds on the magnetic field strength that is allowed to be applied to it and exceeding those limits can cause permanent damage; unlike magnetoresistive sensors, Hall effect sensors have a high dynamic range; (3) Omnipolar Sensitivity: magnetic field sensors preferably are capable of detecting north and south polarity magnetic fields and are insensitive to a magnet's pole orientations; and, (4) Omnidirectional Sensitivity: Since an external magnet may be applied in any orientation to any exposed point on the component's surface (e.g., front face, top, bottom, back or sides), magnetic field sensors preferably have a high degree of sensitivity in all three directions (X, Y, and Z).

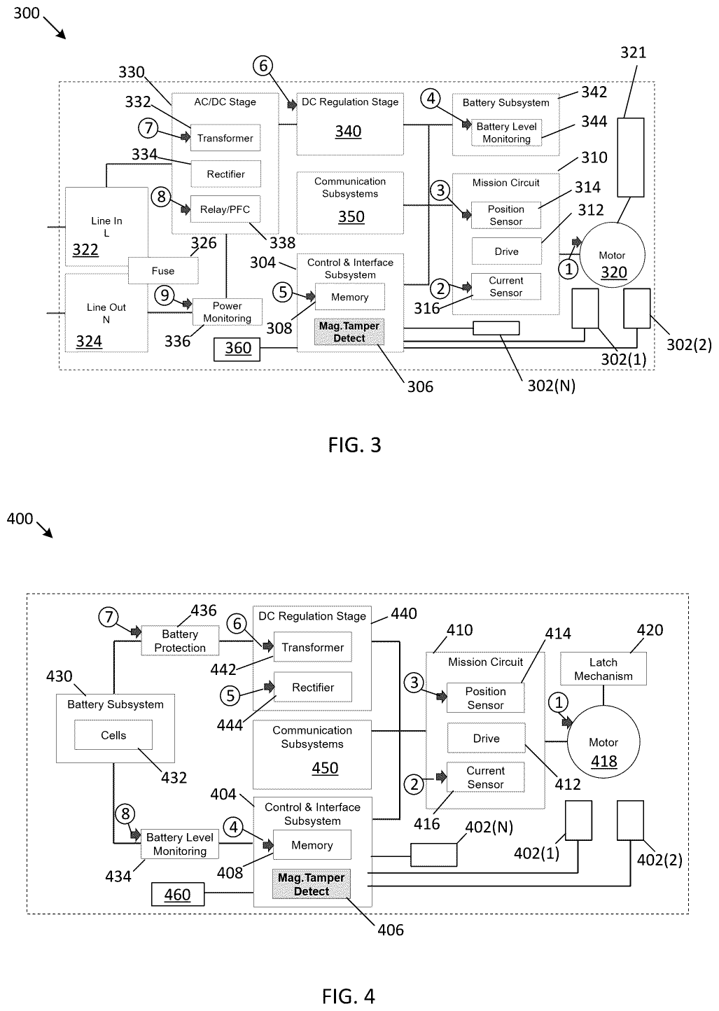

FIG. 3 is a diagram of tampering detection and diagnostics system 300 employed with a smart garage door system, in accordance with the present disclosure. As indicated, system 300 can include a mission circuit 310 operable to control a motor 320, e.g., that is configured to open and close a garage door or gate 321. System 300 can include multiple magnetic field sensors, e.g., as indicated by 302(1)-(N) for monitoring magnetic fields incident on or applied to system 300, including stray magnetic fields such as those generated by tampering events.

System 300 can include a control and interface subsystem 304. Subsystem 304 may be used to control components of system 300 and/or provide a user interface for use of system 300. Subsystem 304 may include a controller or processor 306 and memory 308. Processor 306 may be configured to detect magnetic tampering events and/or provide diagnostics regarding detected magnetic fields.

System 300 can be configured to receive power, e.g., AC power from a mains (utility) power supply, as indicated by line-in block 322 and line-out block 324. System 300 can include a power conversion (AC/DC) stage 330 for converting AC power to DC power. The power conversion stage 330 can include a transformer 332, a rectifier 334, and a relay/power factor control (PFC) block 338 for adjusting or correcting a power factor of the supplied power, as shown. System 300 can also include a power monitoring block 336 and fuse 326.

System 300 can include a DC regulation stage 340 having DC regulation circuitry. The DC regulation circuitry may include DC conversion circuitry. For example, the DC regulation circuitry may include a buck regulator, a boost regulator, a magnetic DC-DC convertor, a buck-boost convertor, and/or a flyback convertor having a transformer. System 300 can include a battery subsystem 342. Battery subsystem 342 can include a battery level monitoring block 344.

System 300 can include a communication subsystem 350. Subsystem 350 can include suitable communication functionality, e.g., for programming, usage, and/or to relay or store data. This functionality can include, but is not limited to, Internet, wireless, hard-wired, and/or modem functionality to provide for real-time or non-real-time connection to one or more communication networks outside of system 300. Examples of such connectivity can include, but are not limited to wired connections, e.g., Ethernet, Internet, fiberoptic cable, RS232, SPI, etc. and/or wireless connections, e.g., WiFi, IEEE 802.11x, 2G, 3G, 4G, 5G, etc.

System 300 can also include latching (compensation) circuitry 360 that functions to activate in response to a magnetic field measurement signal exceeding a predetermined or programmed latch threshold. For example, the latching circuitry 360 may be configured to apply compensation for a magnetic field measurement signal from one or more magnetic field sensors 302(1)-(N) exceeding the latch threshold. The latching circuitry 360 can be configured to deactivate the device, e.g., motor 320, for a predetermined period of time in response to a magnetic field measurement signal exceeding the latch threshold. The latching circuitry 360 can be configured to apply compensation including an attenuation of the magnetic field measurement signal, e.g., apply attenuation to the magnetic field signals exceeding the latch threshold. The latching circuitry 360 can be configured to apply a countering effect to the device to counter the effect of the magnetic tampering event, e.g., causing a coil to produce a magnetic field of opposite polarity to the applied stray field to reduce the combined magnetic field at locations of one or more magnetic field sensors 302(1)-(N).

In some examples, compensation can include adjustment of the magnetic field sensitivity of the magnetic sensors 302(1)-(N) used fora device or component. For example, some magnetic field sensor ICs include EEPROM memory that can house or include settings for magnetic field sensitivity; compensation for a stray field can be controlled or implemented (potentially, in real-time or near real-time) by modifying the memory settings (for magnetic field sensitivity) of the magnetic field sensors 302(1)-(N) used for any device(s) or component(s) affected by a magnetic stray field. Such magnetic field sensitivity adjustment may be controlled or implemented by a suitable controller or control circuit e.g., processor 306 or control and interface sub-system 304, and/or suitable circuitry such as, e.g., latching circuitry 360.

In FIG. 3, locations 1-9 (indicated by arrows) refer to example components of system 300 that may be particularly susceptible to magnetic tampering; of course, those locations are a non-exhaustive representation of susceptible points in system 300 and others may be present instead or in addition to those shown. Locations 1-9 are as follow: location 1 is at motor 320; location 2 is at current sensor 316 of mission circuit 310; location 3 is at position sensor 314 of mission circuit 310; location 4 is at battery level monitory block 344 of battery subsystem 342; location 5 is at memory 308 of control and interface subsystem 304; location 6 is at DC regulation stage 340; location 7 is at transformer 332 of power conversion stage 330; location 8 is at relay/PFC block 338; and, location 9 is at power monitoring block 336. One or more magnetic field sensors, e.g., 302(1)-(N), may be configured or positioned to detect magnetic fields at locations 1-9 and/or others.

System 300 can be used to detect attempts at magnetic tampering. System 300 can be used, in some examples, to take remedial action in response to a detected tampering event. In some examples, system 300 can record a data log of measurements from magnetic field sensors 302(1)-(N). In some examples, system 300 can perform a remedial action such as producing an alert, disabling critical parts of the system 300, or notifying an administrator, and/or others. For example, if control and interface subsystem 304 were to determine a sensor reading from one of sensors 302(1)-(N) indicated that a magnetic field at a particular system component exceeded a threshold (in amplitude and/or time), control and interface subsystem 304 could control motor 320 to move the door 321 to a closed (secured) position to thwart unauthorized access to an area adjacent to the door 321.

FIG. 4 is a diagram of an example of a tampering detection and diagnostics system 400 employed with a smart door locking mechanism, in accordance with the present disclosure. System 400 can function to detect magnetic tampering events and/or provide diagnostics related to magnetic field measurements.

System 400 includes multiple magnetic field sensors, e.g., as indicated by 402(1)-(N), for monitoring magnetic fields incident on or applied to system 400, including stray magnetic fields such as those generated by tampering events. System 400 can include a control and interface system 404. The control and interface subsystem 404 can include a controller or processor 406 configured to detect magnetic tampering and/or provide diagnostics related to magnetic field signals from sensors 402(1)-(N). Control and interface subsystem 404 can also include memory 404. System 400 can include a mission circuit 410 for controlling motor 418 and latch mechanism 420.

System 400 can include a battery subsystem 430 with one or more battery cells 432. System 400 can include a battery protection block 436 and a battery level monitoring block 434. System 400 can include a DC regulation stage 440 having DC regulation circuitry. The DC regulation circuitry may include DC conversion circuitry. For example, the DC regulation circuitry may include a buck regulator, a boost regulator, a magnetic DC-DC convertor, a buck-boost convertor, and/or a flyback convertor having a transformer.

System 400 can include a communication subsystem 450. Subsystem 450 can include suitable communication functionality, e.g., for programming, usage, and/or to relay or store data. This functionality can include, but is not limited to, Internet, wireless, hard-wired, and/or modem functionality to provide for real-time or non-real-time connection to one or more communication networks outside of system 400. Examples of such connectivity can include, but are not limited to wired connections, e.g., Ethernet, Internet, fiberoptic cable, RS232, SPI, I2C, etc. and/or wireless connections, e.g., WiFi, IEEE 802.11x, 2G, 3G, 4G, 5G, etc.

System 400 can also include latching circuitry 460 that is configured and/or controlled to activate in response to a magnetic field measurement signal exceeding a predetermined or programmed latch threshold. For example, the latching circuitry 460 may be configured to apply compensation for a magnetic field measurement signal from one or more magnetic field sensors 402(1)-(N) exceeding the latch threshold. The latching circuitry 460 can be configured to deactivate the device, e.g., motor 418, for a predetermined period of time in response to a magnetic field measurement signal exceeding the latch threshold. The latching circuitry 460 can be configured to apply compensation comprising an attenuation of the magnetic field measurement signal, e.g., apply attenuation to the magnetic field signals exceeding the latch threshold. The latching circuitry 460 can be configured to apply a countering effect to the device to counter the effect of the magnetic tampering event, e.g., causing a coil to produce a magnetic field of opposite polarity to the applied stray field to reduce the combined magnetic field at locations of one or more magnetic field sensors 402(1)-(N).

As noted above, compensation to address a stray magnetic field, e.g., tampering event, can include adjusting the magnetic field sensitivity (e.g., by lowering sensitivity) of one or more magnetic field sensors 402(1)-(N). In some examples, adjustment of magnetic field sensitivity can be performed by latching circuitry 460 and/or control and interface sub-system 404 and/or another control system/circuit. In some examples, adjustment of magnetic field sensitivity of a magnetic field sensor may include adjusting EEPROM setting(s) of the sensor.

In FIG. 4, locations 1-8 (shown by arrows) indicate example system components that may be potentially susceptible to magnetic tampering; of course, those locations are a non-exhaustive representation of susceptible points in system 400 and others may be present instead or in addition to those shown. Locations 1-8 are as follow: location 1 is at motor 418; location 2 is at current sensor 416 of mission circuit 410; location 3 is at position sensor 414; location 4 is at memory 408; location 5 is at rectifier 444; location 6 is at transformer 442; location 7 is at battery protection block 436; and location 8 is at battery level monitoring block 434. One or more magnetic field sensors, e.g., 402(1)-(N), may be configured or positioned to detect magnetic fields at locations 1-8 or others.

As system 400 includes battery supplied power from batter subsystem 430, example embodiments may be included on non-stationary platforms, e.g., included on or in movable platforms such as motor vehicles or aircraft, etc. For example, system 400 could be employed in an automobile to detect magnetic tampering of vehicle door locks. In some examples, system 400 may be employed with or on an electric vehicle, e.g., an electric vehicle configured to receive charging power from a direct-coupling charging system., e.g., charging station, or inductively, e.g., from a roadbed (sub surface) charging system. System 400 may accordingly be used to monitor magnetic fields from such charging systems for tampering events and/or operational conditions of those charging systems, e.g., excessive charging fields, etc.

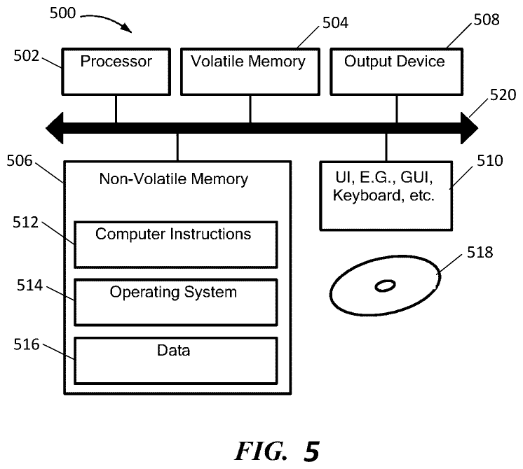

FIG. 5 is a block diagram of an example computer system 500 operative to perform processing, in accordance with the present disclosure. Computer system 500 can perform all or at least a portion of the processing, e.g., steps in the algorithms and methods, described herein. The computer system 500 includes a processor 502, a volatile memory 504, a non-volatile memory 506 (e.g., hard disk), an output device 508 and a user input or interface (UI) 1010, e.g., graphical user interface (GUI), a mouse, a keyboard, a display, and/or any common user interface, etc. The non-volatile memory (non-transitory storage medium) 506 stores computer instructions 512 (a.k.a., machine-readable instructions or computer-readable instructions) such as software (computer program product), an operating system 514 and data 516. In one example, the computer instructions 512 are executed by the processor 502 out of (from) volatile memory 504. In one embodiment, an article 518 (e.g., a storage device or medium such as a hard disk, an optical disc, magnetic storage tape, optical storage tape, flash drive, etc.) includes or stores the non-transitory computer-readable instructions. Bus 520 is also shown.

Processing may be implemented in hardware, software, or a combination of the two. Processing may be implemented in computer programs (e.g., software applications) executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., a port or bus) to perform processing and to generate output information.

The system 500 can perform processing, at least in part, via a computer program product or software application, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. Further, the terms “computer” or “computer system” may include reference to plural like terms, unless expressly stated otherwise.

Processing may be performed by one or more programmable processors executing one or more computer programs to perform the functions of the system. All or part of the system may be implemented as, special purpose logic circuitry, e.g., an FPGA (field programmable gate array) and/or an ASIC (application-specific integrated circuit). In some examples, digital logic circuitry, e.g., one or more FPGAs, can be operative as a processor as described herein. Accordingly, embodiments of the inventive subject matter can afford various benefits relative to prior art techniques and system/devices. For example, embodiments and examples of the present disclosure can enable or facilitate e.g., detection of tampering events or attempted tampering. Remedial actions can be performed in response to detected tampering events. In some examples, a log can be recorded, an alert can be produced, critical system parts/components may be disabled, and/or notifications or warning can be issued, e.g., to a system user or administrator. Tamper prevention can be realized at the point of the end equipment's use, by having, e.g., the proper safeguards in place like detection, lockout and notification, or a form of compensation when continuing with operation. In some examples, a system may intentionally disable itself for a short period of time if a very strong stray field tamper attempt is detected, or it may log and disregard the stray field if it is considered weak enough. A tamper prevention mechanism can be used, e.g., when critical sensitive electronics are present and their malfunction could cause a hazard, or in the case of the smart lock, a security breach. Moreover, magnetic tamper detection in accordance with the present disclosure may be employed to prevent malfunctions and enable a system-level response to a hazardous magnetic field exposure event, enhancing the overall security and performance of smart security systems/devices and/or other electronic devices.

Various embodiments of the concepts, systems, devices, structures, and techniques sought to be protected are described above with reference to the related drawings. Alternative embodiments can be devised without departing from the scope of the concepts, systems, devices, structures, apparatus, and techniques/methods described. For example, while reference is made above to a current sensor IC with a single set of magnetic field sensing elements, other examples and implementations may include multiple sets or constellations of magnetic field sensing elements at any desired distance from a processor or IC associated with the sensor. The corresponding system model could include the positions of the multiple sets or constellations of magnetic field sensing elements.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture, or an article, that includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. The term “connection” can include an indirect “connection” and a direct “connection”.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A magnetic field tampering detection system for detecting a tampering event for a n electronic security device, the system comprising:
a memory; and
a processor coupled to the memory and configured to receive a magnetic field measurement signal from one or more magnetic field sensors configured to detect a magnetic field incident on the device, wherein the processor is configured to determine when the magnetic field measurement signal corresponds to a tampering event outside of a normal range of operation, and wherein the processor is configured to generate a response when a tampering event is determined to have occurred.

2. The system of claim 1, wherein the memory comprises computer-executable instructions, and wherein the processor is operative to execute the computer-executable instructions, the computer-executable instructions causing the processor to:
a. receive the magnetic field measurement signal from the one or more magnetic field sensors configured to detect a magnetic field incident on the device;
b. perform a comparison of the magnetic field measurement signal to a normal range of operation;
c. determine that a parameter of the comparison indicates a tampering event was associated with the magnetic field measurement signal; and
d. initiate a response to the tampering event.

3. The system of claim 1, wherein the response includes disabling the device for a period of time.

4. The system of claim 1, wherein the response includes disabling a user input to the device fora period of time.

5. The system of claim 1, wherein the processor is further configured to generate a notification in response to the tampering event.

6. The system of claim 1, wherein the processor is further configured to apply compensation to the magnetic field measurement signal from the one or more sensors in response to the tampering event.

7. The system of claim 6, wherein the compensation comprises an attenuation factor sufficient to place the magnetic field measurement signal in a normal range of operation.

8. The system of claim 1, wherein the system is configured to detect an alternating magnetic field as a tampering event.

9. The system of claim 1, wherein the system is configured to detect a static electric field as a tampering event.

10. A magnetic tampering detection system for detecting a tampering event for an electronic device, the system comprising:
one or more magnetic field sensors, each configured to detect a stray magnetic field at a respective location of the device;
a memory comprising computer-executable instructions; and
a processor coupled to the memory and operative to execute the computer-executable instructions, the computer-executable instructions causing the processor to:
a. receive a magnetic field measurement signal from the one or more magnetic field sensors;
b. perform a comparison of the magnetic field measurement signal to a normal range of operation;
c. determine that a parameter of the comparison indicates a tampering event was associated with the magnetic field measurement signal; and
d. initiate a response to the tampering event.

11. The system of claim 10, wherein the one or more magnetic field sensors comprise omnipolar sensors.

12. The system of claim 10, wherein the one or more magnetic field sensors comprise omnidirectional sensors.

13. The system of claim 10, wherein the one or more magnetic field sensors comprise Hall effect elements.

14. The system of claim 10, wherein the one or more magnetic field sensors comprise multi-axis Hall effect sensors.

15. The system of claim 10, wherein the one or more magnetic field sensors comprise magnetoresistance elements.

16. The system of claim 10, wherein the device comprises an actuator.

17. The system of claim 10, wherein the device comprises a current meter.

18. The system of claim 10, wherein the device comprises a position sensor, wherein the one or more magnetic field sensors are configured to detect a stray magnetic field at the position sensor.

19. The system of claim 10, wherein the device comprises a current sensor, wherein the one or more magnetic field sensors are configured to detect a stray magnetic field at the current sensor.

20. The system of claim 10, wherein the device comprises a motor driver integrated circuit, wherein the one or more magnetic field sensors are configured to detect a stray magnetic field at the motor driver integrated circuit.

21. The system of claim 10, wherein the device comprises an actuator, wherein the one or more magnetic field sensors are configured to detect a stray magnetic field at the actuator.

22. The system of claim 10, wherein the device comprises one or more memories, wherein the one or more magnetic field sensors are configured to detect a stray magnetic field at the one or more memories.

23. The system of claim 10, wherein the device comprises DC regulation circuitry, wherein the one or more magnetic field sensors are configured to detect a stray magnetic field at the DC regulation circuitry.

24. The system of claim 23, wherein the DC regulation circuitry comprises DC conversion circuitry.

25. The system of claim 24, wherein the DC regulation circuitry comprises a buck regulator.

26. The system of claim 24, wherein the DC regulation circuitry comprises a boost regulator.

27. The system of claim 24, wherein the DC regulation circuitry comprises a magnetic DC-DC convertor.

28. The system of claim 24, wherein the DC regulation circuitry comprises a buck-boost convertor.

29. The system of claim 24, wherein the DC regulation circuitry comprises a flyback convertor having a transformer.

30. The system of claim 10, wherein the device comprises power monitoring circuitry, wherein the one or more magnetic field sensors are configured to detect a stray magnetic field at the power monitoring circuitry.

31. The system of claim 30, wherein the power monitoring circuitry comprises voltage monitoring circuitry.

32. The system of claim 30, wherein the power monitoring circuitry comprises current monitoring circuitry.

33. The system of claim 10, wherein the device comprises battery level monitoring circuitry, wherein the one or more magnetic field sensors are configured to detect a stray magnetic field at the battery level and health monitoring circuitry.

34. The system of claim 10, wherein the device comprises battery protection circuitry, wherein the one or more magnetic field sensors are configured to detect a stray magnetic field at the battery protection circuitry.

35. The system of claim 10, wherein the device comprises charging circuitry, wherein the one or more magnetic field sensors are configured to detect a stray magnetic field at the charging circuitry.

36. The system of claim 10, wherein the processor, memory, and one or more magnetic field sensors are disposed in an integrated circuit.

37. The system of claim 27, wherein the device comprises a current sensor.

38. The system of claim 10, further comprising a magnetic proximity detection sensor configured to detect movement of the device relative to an installation position.

39. The system of claim 10, further comprising latching circuitry configured to activate in response to the magnetic field measurement signal exceeding a latch threshold, wherein the latching circuitry is configured to apply compensation for the magnetic field measurement signal exceeding the latch threshold.

40. The system of claim 39, wherein the latching circuitry is configured to deactivate the device for a predetermined period of time in response to the magnetic field measurement signal exceeding the latch threshold.

41. The system of claim 39, wherein the latching circuitry is configured to apply compensation comprising an attenuation of the magnetic field measurement signal.

42. The system of claim 39, wherein the latching circuitry is configured to apply a countering effect to the device to counter the effect of the magnetic tampering event.

43. The system of claim 39, wherein the latching circuitry is configured to apply compensation comprising an adjustment of magnetic field sensitivity of one or more of the magnetic field sensors.

44. The system of claim 43, wherein the adjustment comprises a reduction in magnetic field sensitivity.
